(19) United States
(12) Patent Application Publication
(10) Pub. No.: US 2010/0187470 A1
(43) Pub. Date: Jul. 29, 2010

(54) FINE CERIUM OXIDE POWDER AND PREPARING METHOD THE SAME AND CMP SLURRY COMPRISING THE SAME

(76) Inventor: Seung Joo Lee, Daejeon (KR)

Correspondence Address: MCDERMOTT WILL & EMERY LLP, 600 13TH STREET, N.W., WASHINGTON, DC, 20005-3096, US

(21) Appl. No.: 12/601,630

(22) PCT Filed: Mar. 18, 2009
(86) PCT No.: PCT/KR2009/001370

§ 371 Date: Nov. 24, 2009

(30) Foreign Application Priority Data
Jul. 16, 2008 (KR) 10-2008-0069155

(51) Int. Cl. C09K 13/00; C01F 17/00

(52) U.S. Cl. 252/79.1; 423/263; 428/402; 977/773

(57) ABSTRACT

Disclosed is a method of preparing cerium oxide (CeO₂) by forming cerous nitrate hexahydrate as an intermediate through adjustment of the acidity of a cerium precursor. More particularly, disclosed is fine cerium oxide powder, a preparation method of the same, and CMP slurry including the same. The method includes the steps of: titrating a cerium chloride composition with sodium hydroxide; separating the titrated cerium chloride composition into a supernatant and a precipitation; collecting a cerium precursor as the first precipitation through filtration; titrating the cerium precursor with nitric acid of a predetermined concentration so that acidity (pH) of the cerium precursor is within a range of 4˜4.5; and forming cerous nitrate hexahydrate whose initial particle size is finely crystallized. Due to the fine and uniform particle size of the cerous nitrate hexahydrate, the cerium oxide can have high crystallinity and greatly improve various kinds of polishing properties.

### TECHNICAL FIELD

The present invention relates to a method for preparing cerium oxide by forming cerous nitrate hexahydrate as an intermediate through adjustment of the acidity of a cerium precursor, and more particularly to fine cerium oxide powder, a preparation method of the same, and CMP slurry including the same, in which the fine cerium oxide powder is prepared by using, as an intermediate, cerous nitrate hexahydrate whose initial particle size is finely crystallized by the acidity adjustment of a cerium precursor, and thus can greatly improve various kinds of polishing properties due to its fine and uniform particle size.

### BACKGROUND ART

As generally known in the art, cerium oxide (CeO₂) powder is a highly functional ceramic powder that is widely used as the raw materials of polishing agents, catalysts, fluorescent substances, and the like, and has recently been spotlighted as a chemical mechanical polishing (CMP) agent for the selective planarization of a semiconductor substrate. Such cerium oxide powder is generally prepared by a gas-phase method, a solid-phase method, and a liquid-phase method.

The gas-phase method for preparing cerium oxide powder is a method of preparing cerium oxide directly by vaporizing a cerium metal salt precursor and combining the vaporized precursor with oxygen, etc., and is subdivided into a flame combustion decomposition method, a gas condensation decomposition method, a plasma decomposition method, a laser vaporization method, and the like. However, this liquid-phase method has difficulty in mass production because the unit cost of the cerium metal salt precursor and equipment costs are expensive.

The solid-phase method for preparing cerium oxide powder is a method of preparing cerium oxide from a raw material, such as carbonates, sulfates, and oxalates, through a calcination process. For example, International Patent Publication Nos. WO 1998/14987 and WO 1999/31195 disclose cerium oxide polishing agents that are prepared by calcining large particle-sized cerium carbonate powder in an oxygen atmosphere to obtain cerium oxide powder with a particle size of 30 to 100 μm and subjecting the cerium oxide powder to dry or wet grinding to adjust the particle size thereof. However, there is a problem in that since coarse cerium oxide powder remains even after the grinding process of the cerium oxide powder, it is difficult to adjust its particle size, on account of which a filtration process must be also performed for a long time after the final CMP is prepared.

The liquid-phase method for preparing cerium oxide powder is a method of preparing cerium oxide directly from a trivalent or tetravalent cerium salt starting material with the addition of a pH adjuster, such as ammonia, and is subdivided into a precipitation method, a hydrothermal method, and the like. Since raw material and equipment costs are inexpensive, research on the liquid-phase method is being actively conducted. Compared to the solid-phase method, the liquid-phase method can synthesize cerium oxide with a relatively fine particle size because grain growth proceeds in a micron-nucleation step. However, there is a problem in that needle-shaped cerium oxide is synthesized due to the difficulty in synthesizing high crystallinity particles, thereby causing many scratches on the surface of an object to be polished.

For example, Korean Patent Application Laid-Open No. 2007-32907 (Title: Cerium Carbonate Powder, Cerium Oxide powder, Method for Preparing the Same, and CMP Slurry Comprising the Same) discloses cerium carbonate powder that is prepared by adjusting the molar concentration of a cerium precursor and a carbonate precursor, and mixing at least one kind of additive with them, cerium oxide powder that is prepared by subjecting the cerium carbonate powder to heat treatment, and CMP slurry using the cerium oxide powder as a polishing agent.

However, the cerium oxide prepared by using such a liquid-phase method has relatively fine particles with a particle diameter within a range of 5 to 10 nm, but is synthesized in a needle-shape due to the difficulty in improving the crystallinity of a cerium precursor of a cerium precursor solution as an intermediate. Thus, a cerium oxide powder formed by grinding such cerium oxide has non-uniform particle size distribution, which has a negative influence on the physical property. Moreover, in preparing CMP slurry, when such cerium oxide powder is used as a polishing agent, many scratches may occur on an object to be polished by the CMP slurry (for example, 15-30 scratches per 30 inch wafer as the object to be polished), which may cause quality deterioration of an electronic product fabricated using a wafer.

### DISCLOSURE

Technical Problem

Therefore, the present invention has been made in view of the above-mentioned problems, and the present invention provides fine cerium oxide powder, a preparation method of the same, and CMP slurry including the same, in which the fine cerium oxide powder is prepared by using, as an intermediate, cerous nitrate hexahydrate whose initial particle size is finely crystallized by the acidity adjustment of a cerium precursor, and thus can greatly improve various kinds of polishing properties due to its fine and uniform particle size.

Technical Solution

In accordance with an aspect of the present invention, there is provided a method of preparing fine cerium oxide powder, the method including the steps of: titrating a cerium chloride composition with sodium hydroxide of a predetermined concentration, separating the titrated cerium chloride composition into a first supernatant and a first precipitation, and collecting a cerium precursor as the first precipitation through filtration; titrating the cerium precursor with nitric acid of a predetermined concentration so that acidity (pH) of the cerium precursor is within a range of 4˜4.5, and thereby forming cerous nitrate hexahydrate; mixing the cerous nitrate hexahydrate with a carbonate precursor aqueous solution, separating a resultant mixture into a second supernatant and a second precipitation through a precipitation reaction, and collecting the second precipitation through filtration; and; and calcining the second precipitation at predetermined temperature, and forming cerium oxide powder through grinding.

In accordance with another aspect of the present invention, there is provided fine cerium oxide powder prepared by the method.

In accordance with a further aspect of the present invention, there is provided CMP slurry including high-purity cerium oxide powder prepared by the method.

Advantageous Effects

The fine cerium oxide powder according to the present invention, which is prepared by using, as an intermediate, cerous nitrate hexahydrate having a fine and uniform initial particle size by the acidity adjustment of a cerium precursor, has a crystalline particle with a particle diameter within a range of 1˜2 nm, and thus can have high crystallinity and can greatly improve various kinds of polishing properties.

Also, the CMP slurry including the fine cerium oxide powder according to the present invention causes very few scratches on the surface of a wafer (a main object to be polished), and thus can secure the quality of electronic products which use such wafers.

Best Mode

Hereinafter, a preparation method of fine cerium oxide powder according to the present invention will be described with reference to exemplary embodiments.

First, a method of preparing fine cerium oxide powder according to the present invention includes the steps of titrating a cerium chloride composition with sodium hydroxide so that the pH of the cerium chloride composition is within a range of 9 to 10, separating the titrated cerium chloride composition into a first supernatant and a first precipitation, and collecting a cerium precursor as the first precipitation through filtration.

A cerium chloride composition is prepared by treating cerite, a raw mineral material of cerium, with chlorine gas, and then a cerium precursor (intermediate of cerium oxide) is obtained by adjusting the acidity of the cerium chloride composition by a pH adjuster and carrying out purification.

Specifically, when the cerium chloride composition is titrated with a pH adjuster (sodium hydroxide) so as to form a reaction system, the titration of sodium hydroxide alkalizes the acidity (pH) of the reaction system within a range of 9˜10. Then, the cerium chloride composition of the reaction system is precipitated and is separated into a first supernatant and a first precipitation. If sodium hydroxide is supplied to the cerium chloride composition at once, an intense exothermic reaction occurs in the reaction system. Therefore, for the titration, sodium hydroxide is added drop by drop to the cerium chloride composition, and thus the exothermic reaction is adjusted while separating the reaction system into the first supernatant and the first precipitation. In the reaction system whose acidity has been adjusted to be alkaline by the above described titration of sodium hydroxide, the cerium chloride composition is precipitated and separated into the first supernatant and the first precipitation.

In forming the reaction system, there is no limitation in the concentration of sodium hydroxide to be used for titration of the cerium chloride composition. However, in order to achieve the object of the present invention, (that is, preparation of fine cerium oxide powder), the cerium chloride composition is required to be titrated with sodium hydroxide so that the acidity (pH) of the reaction system is within a range of 9˜10 while being separated into the first supernatant and the first precipitation.

When the acidity (pH) of the reaction system formed by the titration of cerium chloride composition with sodium hydroxide is less than 9, the reaction system is not clearly separated into the first supernatant and the first precipitation, and on the other hand, when the acidity (pH) of the reaction system formed by the titration of cerium chloride composition with sodium hydroxide is greater than 10, Nd and Sm contained in the cerium chloride composition are not appropriately dispersed in the first supernatant.

The reaction system, which is separated into the first supernatant and the first precipitation as described above, is subjected to filtration, and thereby, the first precipitation is collected. Then, the step of forming a cerium precursor is carried out.

Also, the method of preparing the fine cerium oxide powder according to the present invention includes the steps of titrating the cerium precursor with nitric acid so that the acidity (pH) of the cerium precursor is within a range of 4˜4.5, and forming cerous nitrate hexahydrate.

The cerous nitrate hexahydrate (which is an inducer of cerium) is formed by mixing the cerium precursor from the cerium precursor forming step with nitric acid and then inducing the substitution reaction of the reaction system. However, since the cerium precursor cannot be sufficiently crystallized during the substitution reaction of the reaction system, the formed cerous nitrate hexahydrate has a needle shaped particle with an initial particle diameter within a range of 5˜10 nm. Thus, there is a problem in that cerium oxide formed from the cerous nitrate hexahydrate also has a needle shaped particle with an average particle diameter within a range of about 5˜10 nm, and has a non-uniform particle size distribution.

In order to solve the above mentioned problem, the inventors of the present invention carried out long-term researches and repeated experiments many times. As a result, they found that when the acidity of the reaction system formed by mixing the cerium precursor with nitric acid is maintained within a very narrow range of critical acidity, the cerium precursor can be appropriately crystallized during the substitution reaction of the reaction system, thereby forming cerous nitrate hexahydrate having a crystalline particle with an initial particle diameter within a range of 1˜2 nm.

In other words, when the reaction system is formed by titrating the cerium precursor (having alkalinity by the titration of sodium hydroxide) with nitric acid so that the reaction system has acidity (pH) within a range of 4˜4.5, the cerium precursor having a critical acidity (pH) of 4˜4.5 is appropriately crystallized, thereby forming a cerous nitrate hexahydrate which has a crystalline particle with an initial particle diameter within a range of 1˜2 nm. When the acidity (pH) of the reaction system formed by mixing the cerium precursor with nitric acid is less than 4, the cerium precursor of the reaction system is not appropriately crystallized, and on the other hand, when the acidity (pH) of the reaction system formed by mixing the cerium precursor with nitric acid is greater than 4.5, the yield of the cerous nitrate hexahydrate formed in the reaction system is reduced.

In conclusion, when the acidity (pH) of the reaction system is within a critical range of 4˜4.5, it is possible to prepare cerous nitrate hexahydrate having a crystalline particle with an initial particle diameter within a range of 1˜2 nm from the reaction system, and on the other hand, when the acidity (pH) of the reaction system is out of the critical range of 4˜4.5, the cerous nitrate hexahydrate has a needle shaped particle with an initial particle diameter within a range of 5˜10 nm.

As described above, in forming the cerous nitrate hexahydrate (which is an inducer of cerium) by mixing the cerium precursor formed from the cerium precursor forming step with nitric acid and then inducing the substitution reaction of the reaction system, when the nitric acid is added to the cerium precursor at once, the intense exothermic reaction occurs in the reaction system. Therefore, for the titration, nitric acid is added drop by drop to the cerium precursor, and thus the exothermic reaction is adjusted while forming the cerous nitrate hexahydrate (an inducer of cerium).

In forming the reaction system, there is no limitation in the concentration of nitric acid to be used for titration of the cerium precursor. However, in order to achieve the object of the present invention, (that is, the preparation of fine cerium oxide powder), the cerium precursor is required to be titrated with nitric acid so that the acidity (pH) of the reaction system is within a range of 4˜4.5 while forming the cerous nitrate hexahydrate.

To the cerous nitrate hexahydrate obtained as described above, a liquid-phase method is applied to prepare cerium oxide.

Also, the method of preparing fine cerium oxide powder according to the present invention includes the steps of mixing the cerous nitrate hexahydrate with a carbonate precursor aqueous solution, separating the resultant mixture into a second supernatant and a second precipitation through a precipitation reaction, and collecting the second precipitation through filtration.

The cerous nitrate hexahydrate (an inducer of cerium) is mixed with a predetermined amount of carbonate precursor aqueous solution (such as an urea aqueous solution), and then left for a predetermined time, thereby inducing a precipitation reaction. Thereafter, the resultant mixture is separated into a second supernatant and a second precipitation, and then the second precipitation is collected through the filtration of the separated second supernatant and second precipitation.

During the steps of mixing the cerous nitrate hexahydrate with the carbonate precursor aqueous solution and inducing the precipitation reaction, a substitution reaction between the cerous nitrate hexahydrate and the carbonate precursor aqueous solution occurs, thereby forming the second precipitation (cerium oxide). The formed second precipitation is characterized in that it has a crystalline particle with a particle diameter within a range of 1˜2 nm.

Also, the method of preparing fine cerium oxide powder according to the present invention includes the step of calcining the second precipitation at predetermined temperature, and forming cerium oxide powder through grinding

The cerium oxide as the second precipitation formed from the cerous nitrate hexahydrate is solidified through heat-treatment at 900˜1000°, and the solidified cerium oxide is formed into cerium oxide powder through grinding.

When the heat treatment temperature of the cerium oxide as the second precipitation is less than 900°, the cerium oxide is not sufficiently crystallized, and on the other hand, when the temperature is greater than 1000° the particles of the cerium oxide are strongly closed, thereby reducing the dispersibility of the cerium oxide.

The cerium oxide as the second precipitation has an average particle diameter within a range of 1˜2 nm, which is much smaller than that of conventional cerium oxide, and also its particle is formed into a crystalline shape, instead of a needle shape. These characteristics can improve the polishing property of cerium oxide powder formed by grinding the solidified cerium oxide.

In other words, the fine cerium oxide powder prepared by the above described cerium oxide powder preparation method has a crystalline particle with a particle diameter within a range of 1˜2 nm, and very uniform particle size distribution, and thereby can greatly improve the polishing property.

Then, the high-purity cerium oxide powder is mixed as a polishing agent to prepare CMP slurry. Due to the fine and uniform particle size of the cerium oxide powder as a polishing agent, such CMP slurry can also improve the polishing rate by 30% or more and causes very few scratches on the object being polished.

On a 30-inch wafer polished by the CMP slurry according to the present invention, only 1˜5 scratches occur, while on another 30-inch wafer polished by a conventional CMP slurry, 15˜30 scratches occur. In other words, the CMP slurry can improve the quality of electronic products fabricated by using wafers.

1. A method of preparing fine cerium oxide powder, the method comprising the steps of:
titrating a cerium chloride composition with sodium hydroxide so that pH of the cerium chloride composition is within a range of 9 to 10, separating the titrated cerium chloride composition into a first supernatant and a first precipitation, and collecting a cerium precursor as the first precipitation through filtration;
titrating the cerium precursor with nitric acid so that acidity (pH) of the cerium precursor is within a range of 4˜4.5, and thereby forming cerous nitrate hexahydrate (Ce (NO₃)₃.6H₂O);
mixing the cerous nitrate hexahydrate with a carbonate precursor aqueous solution, separating a resultant mixture into a second supernatant and a second precipitation through a precipitation reaction, and collecting the second precipitation through filtration; and
calcining the second precipitation at 900˜1000°, and forming cerium oxide powder having a crystalline particle with a particle diameter within a range of 1˜2 nm through grinding.

2. Fine cerium oxide powder prepared by the method as claimed in claim 1, which has a crystalline particle with a particle diameter within a range of 1˜2 nm.

3. CMP slurry comprising high-purity cerium oxide powder prepared by the method as claimed in claim 1, the cerium oxide powder having a crystalline particle with a particle diameter within a range of 1˜2 nm.
